(19) United States
(12) Patent Application Publication
(10) Pub. No.: US 2018/0359516 A1
(43) Pub. Date: Dec. 13, 2018

(54) Flexible Video Platform with Optional Advertising

(71) Applicant: Konstantin Kevin Gorinshteyn, West Holywood, CA (US)

(72) Inventor: Konstantin Kevin Gorinshteyn, West Holywood, CA (US)

(21) Appl. No.: 16/105,219

(22) Filed: Aug. 20, 2018

Related U.S. Application Data
(63) Continuation-in-part of application No. 15/830,179, filed on Dec. 4, 2017, now abandoned.

(51) Int. Cl. H04N 21/431; H04N 21/81; H04N 21/4782

(52) U.S. Cl. CPC H04N 21/4316; H04N 21/4782; H04N 21/812

(57) ABSTRACT

A method for opaquely overlaying ads in a stored or streaming video is described where the user has control over the presence or absence of the ads. The advertisement location on the screen, timing of when the ads appear or disappear relative to the video, and actions taken are fully configurable by an editor, and could include links to online storefronts, static ads, embedded video, forms, feeds or similar.

### PRIOR APPLICATION

This application is a continuation-in-part of U.S. patent application Ser. No. 15/830,179, entitled “Next generation Online video play”, filed on Dec. 4, 2017, said application incorporated herein by reference.

### BACKGROUND

### Technical Field

The system, apparatuses and methods described herein generally relate to video display and editing platforms, and, in particular, to tools for overlaying video advertising on a video stream.

### Description of the Related Art

Advertising in video has been around since the silent movies of the 1920s. In the early days, the film strip of the advertisement was spliced into the movie film at the beginning. When television become popular in the 1950s, this model continued with ads inserted before and after the TV show. Eventually, ads were inserted in the middle of the TV shows. By the year 1990, TV ads were so prevalent that viewers started looking for techniques to eliminate the ads from their shows. Video recorders that allowed fast forwarding through ads were popular.

As the internet became faster and more ubiquitous, users started streaming video from cable companies, YouTube, Vimeo, Hulu, and other services. Some of these services insert ads, typically at a lower frequency than the TV broadcasters. Online ads often to occur before the beginning of the content, and are an annoyance to viewers.

Online video advertising today generally refers to advertising that occurs before, during and/or after a video stream on the internet.

The advertising units used in this instance are pre-roll, mid-roll, and post-roll and all of these ad units are like the traditional spot advertising you see on television, although often they are “cut-down” to be a shorter version than their TV counterparts if they are run online.

Broadcast websites such as Sky.com and itv.com have such advertising on their sites, as do newspaper websites such as The Telegraph, and The Guardian. In 2010, video ads accounted for 12.8% of all videos viewed and 1.2% of all minutes spent viewing video online.

However, video advertising is very distracting for the viewer, forcing the viewer to wait for the desired content to start and perhaps interrupting the video with additional ads. Very little of this advertising is associated with the content.

There is a need in the video industry to provide advertising affiliated with the video content in a way that is not intrusive to the view, and respects the viewer's time. The present inventions address these issues.

### BRIEF SUMMARY OF THE INVENTION

A method of displaying advertisements on a video stream is described herein. The method is made up of the steps of presenting the video stream on a screen of a personal computing device, the video stream displayed in a browser using information from a video reader that incorporates information from a configuration storage. Next, the method incorporates the step of sensing a location of focus on the personal computing device screen. Third, the step of displaying, when the focus is on the video screen portion of the screen, an advertisement, where the advertisement is displayed according to the information from the configuration storage, said information determining when, relative to the start of the video stream, to start displaying the advertisement and when the stop displaying the advertisement.

The method could further include the step of redirecting the screen to a web page located at a hypertext link when the advertisement is clicked. It could also include the step of executing a code snippet when the advertisement is display, permitting access to a third party application. In some embodiments, the video stream is a live stream video and in other embodiments the video stream is a previously recorded stored video. In some embodiments the focus is sensed according to a location of a cursor and in others it is is sensed according to a tap on a touchscreen. The advertisement could be opaque when displayed over the video. The personal computing device could be a smartphone. The information could specify the location of the advertisement on the screen.

Another aspect of the present set of inventions is a personal computing device for displaying advertisements on a video stream. The device includes a screen on the personal computing device, a pointing mechanism for specifying focus on the screen, a network interface for connecting to a video reader, which accesses a video storage and a configuration storage, and a browser operating on the personal computing device, wherein the video stream is presented on the screen of a personal computing device by the browser, using information from the video reader that incorporates information from the configuration storage. An advertisement is displayed on the screen according to the information from the configuration storage, when the focus is on the video screen portion of the screen, said information determining when, relative to the start of the video stream, to start the display of the advertisement and when the stop the display of the advertisement.

The screen could be redirected to a web page located at a hypertext link when the advertisement is clicked. A code snippet could be executed when the advertisement is display, permitting access to a third party application. In some embodiments, the video stream is a live stream video and in other embodiments the video stream is a previously recorded stored video. In some embodiments the focus is sensed according to a location of a cursor and in others it is sensed according to a tap on a touchscreen. The advertisement could be opaque when displayed over the video. The personal computing device could be a smartphone. The information could specify the location of the advertisement on the screen.

### BRIEF DESCRIPTION OF THE DRAWINGS

FIG. 1 shows a video playing on a screen with the user focus on the screen, showing the advertisement.

FIG. 2 shows a video playing on a screen with the user focus off of the screen.

FIG. 3 shows the programming screen for configuring the placement of an advertisement.

FIG. 4 illustrates a software architecture for one embodiment.

FIG. 5 is an electrical diagram of an example personal computing device with a special purpose processor.

### DETAILED DESCRIPTION

There is a strong need in the video display industry for a way to advertise in an unobtrusive manner that allows the user to see the ads when the user is looking to buy, and hide the ads when the viewer simply wants to watch the video content. Prior solutions force the user to watch ads, annoying the viewer, interrupting the content, and wasting the viewer's time. This leads to viewers who are angry with the advertiser, defeating the purpose of the ad. Furthermore, there is a strong need to provide a mechanism for inserting ads at relevant locations in the video stream.

A video reader and back-end facility for inserting advertisements is described here. The ads display when the viewer indicates his desire to see ads and are hidden when the viewer does not want to see them. The video could be stored or a live stream video.

Throughout this document, the term ad and advertisement are used interchangeably.

### User Interface Description

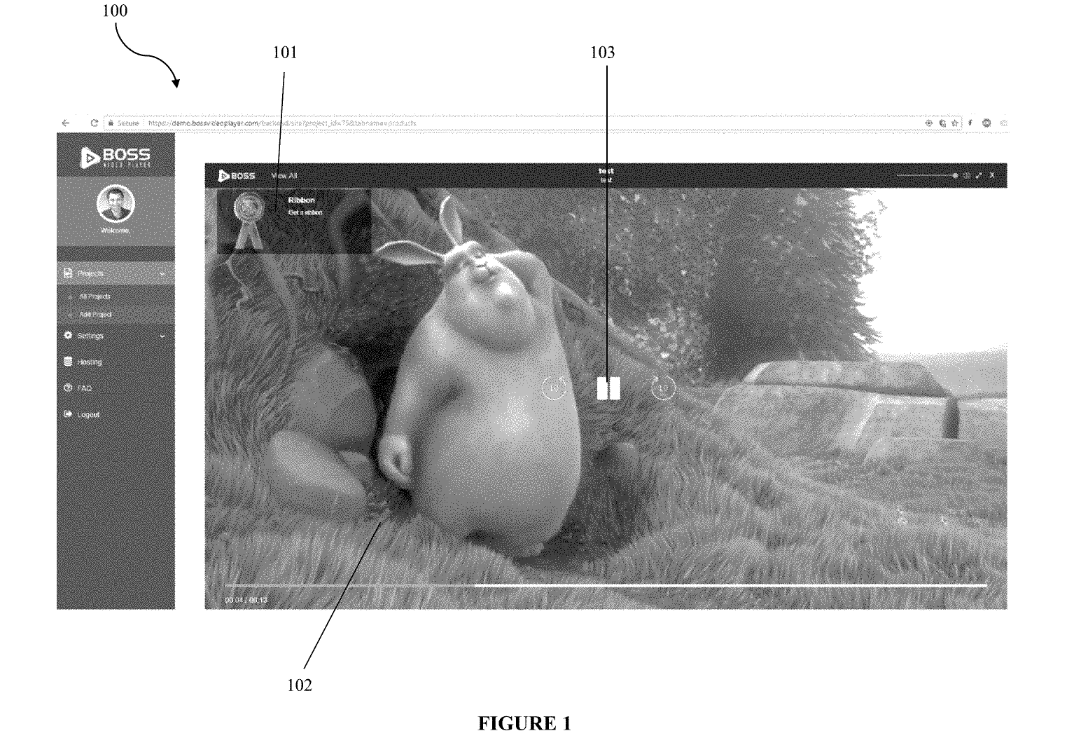

FIG. 1 shows the video reader 100 in the ad view mode. The video 102 is seen on the screen along with an ad 101 in the upper left corner. One or more ads 101 can be displayed over the screen at the same time. If no ads 101 are programmed to display at a point in the video stream, then no ads 101 are overlaid on the video 102. In some embodiments, the ads 101 can be displayed at any location on the screen. The ads 101 could be translucent or opaque, allowing the video behind the ad to be seen. The ads 101 are shown only part of the time in the preferred embodiment. The configuration interface 300 specifies when each ad starts 307 and when it finishes 308, as well as its location on the screen.

Should the viewer click on the ad 101, then the video reader 100 will follow a hyperlink 302 to a specified web page. In one embodiment, the video 102 is paused, and the specified web page is displayed. In a second embodiment, the video 102 continues and the web page is overlaid on the video 102. In still a third embodiment, the web page is spawned into a separate window (or tab or physical screen) and the video continues. In a forth embodiment, the hyperlinked page is displayed in the area reserved for the ad 101.

The user indicates his preference of seeing or not seeing the ads by putting focus on the video 102. On a personal computer, this focus is indicated by using the mouse or touchscreen to place the cursor in the video region 102 of the screen. When the cursor is in the video region 102 of the screen, the video reader 100 overlays the ads 101 on the video 102.

The ads 101 could also be replaced with information on the actors or the music in the background or fun facts. In another embodiment the ads 101 could be replaced with a quiz, either for entertainment or for determining the learning of the viewer, when used for educational purposes.

When in the ad view mode, the video controls 103 could also be displayed on top of the video 102. These controls allow for starting and stopping the video, moving to the start and end of the video. In other embodiments, these controls could allow jumping the video to the next ad insertion location or back to the previous ad insertion location.

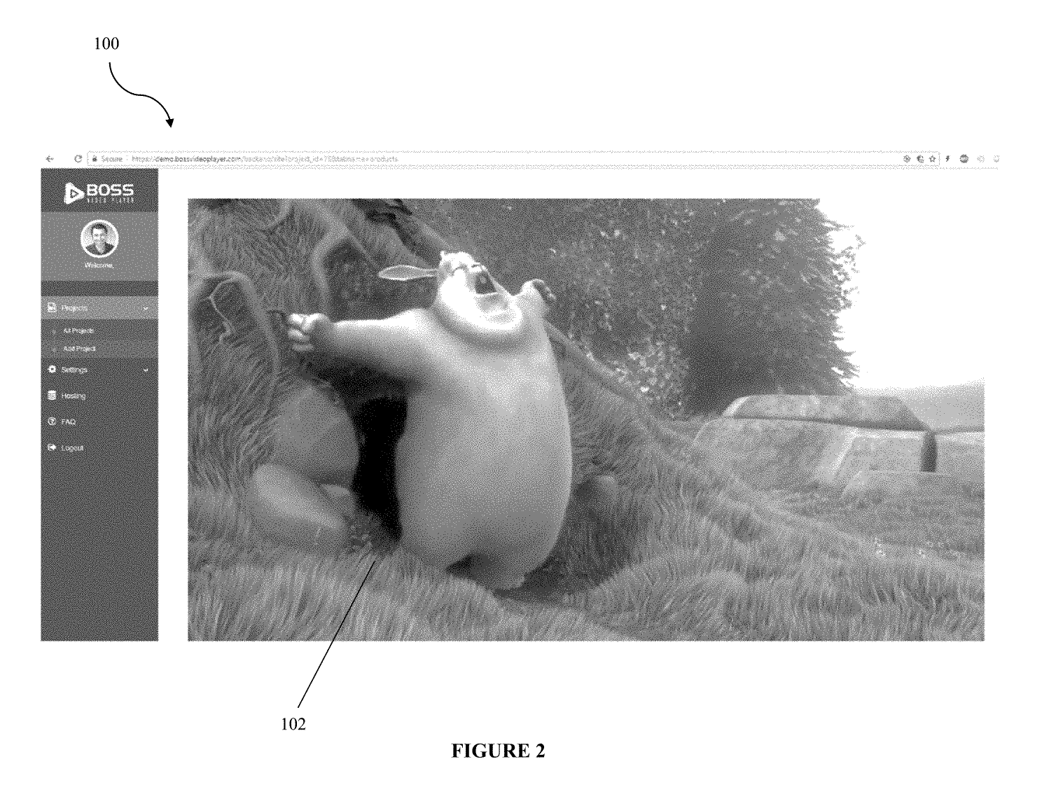

FIG. 2 shows the video reader 100 with the cursor focus off of the video 102. In the no-ad mode, the ads are not shown on the screen. In addition, the video controls are not shown. The video 102 is shown with nothing overlaid on the screen.

To reach the no-ad mode, the viewer moves the cursor off of the video 102 area of the screen, and the ads 101 and the video controls 103 immediately cease being overlaid on the video 102, and disappear from view entirely. Since mobile platforms do not have the cursor and mouse paradigm, the switch from ad view mode to no-ad mode is done by tapping on the screen to toggle the mode.

### Configuration Description

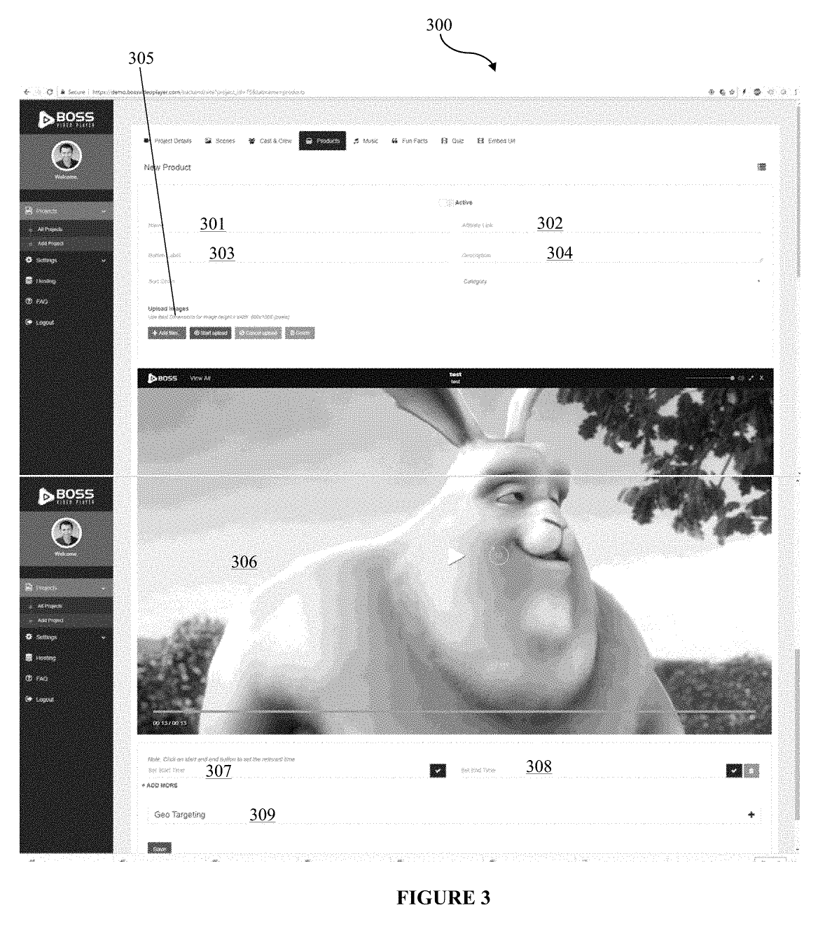

FIG. 3 shows how an editor can insert an ad 101 into a video 102. The editor will use a video configuration tool 300. The editor selects the video 102 to edit and enters the video configuration tool 300. The tool 300 allows the editor to specify the name 301 of the ad and a button 303 associated with the ad. A description 304 of the button 303 can also be specified. The editor also specifies a hypertext link 302 associated with the button 303. When the ad 101 is displayed overlaid on the video 102, a button is active in the location of the ad 101. Should the viewer click on the ad 101, then the hyperlink specified in 302 is activated, the video 102 is paused, and the web page associated with the hyperlink is displayed.

In some embodiments, the hypertext link 302 could be replaced with a code snippet to execute a 3^{rd} party application in the region of the screen defined by the ad 101. This could be a Salesforce.com form, a Twitter feed, a Google Adwords metric count, a Facebook feed, a chat application, or even a video player. There are a limitless number of third party applications that could be incorporated. In another embodiment, this functionality could be added in a separate configuration screen.

The editor can also display a logo or a picture 305 in the button. This is done by specifying a file with the logo or picture, and uploading the file. In some embodiments, multiple files or logos can be uploaded.

When the ad 101 is displayed on the video 102, both the logo/picture, the button label 303 and the description 304 are displayed on the video 102.

The video configuration tool 300 allows the specification of the time 307 to start the display of the ad, relative to the start of the video. The tool 300 also allows specification for the stop time 308 for the ad. This allows the editor to insert ads related to the content of the video at the point in the video where the ad is relevant. For instance, in a home improvement video, say the program “This Old House”, when the craftsman starts using a DeWalt Portable Router to create a custom molding, the video editor could insert a “buy it now” ad for DeWalt Routers on the video only during that segment of the program where the router is used. Clicking on the ad could link to the viewer's Amazon.com account, where the router is ordered with the one click, without interrupting the video.

In some embodiments, the video configuration tool 300 also specifies the location and the size of the ad 101. In another embodiment, the button size and location can be specified, setting the button size and location different from the ad 101 itself

In addition, the video configuration tool 300 allows for geotagging 309 of the ad 101. With geotagging, the editor specifies where the ad will run. For instance, an ad 101 may run only in the USA and Canada. In other cases, the ad 101 may be excluded from certain areas.

In a sophisticated application, the editor may create a Spanish version of the ad to run in Latin America and an English version to run in the USA. A French/English dual language version may run in Canada except Quebec, where a French only version runs.

For live streamed videos, the ads 101 could be specified by number of seconds in which to overlay the ads, as is done with a saved video 102. In another embodiment, a live operator could toggle a Show/Hide button to overlay the ad or remove it from the screen. In still another embodiment, the ads 101 or a group of ads could be triggered when a tag is found in the video stream or where screen analysis software determines that a certain image is found in the video stream. For instance, software could monitor the video stream until facial recognition software determined that Tiger Wood's face appeared on the screen. At that point, ads for a line of Tiger Woods products could be overlaid on the screen, remaining until the facial recognition software determined that Tiger Wood's face is no longer on the video stream.

When the live stream video completes, the video editor software 300 could store the video configuration as a project. The editor software 300 could save the times that the ads 101 were inserted stored as they were inserted in the live video, along with the information on the hyperlinks 302, buttons 303, logos 305, size, and descriptions 304 of the ads 101.

### Software Description

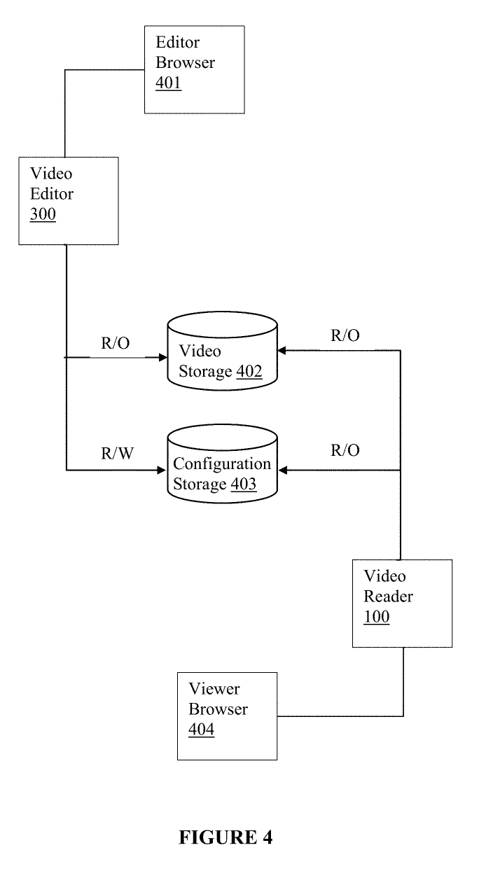

FIG. 4 shows the software architecture for one embodiment for implementing this set of inventions. In this embodiment, the editor starts the editor browser 401 on a personal computing device. The editor browser 401 contacts the video editor 300 server to retrieve the web pages associated with the video editor 300. Some of these pages are described above and in FIG. 3. Internet protocols such as HTTP, TCP/IP, UDP, RTP, and RTCP are used to move the web pages (and the video for editing) from the video editor 300 and the editor browser 401. The editor browser 401 runs on a personal computing device such as a personal computer, a laptop, a mobile phone, a tablet, a smartphone, a smartwatch or similar device.

The video editor 300 is used to read the video 102 as stored in the video storage 402 (or to connect with a live stream video source). The video 102 is not changed by the video editor 300. Instead, the video editor 300 creates and edits configuration storage data 403 associated with the video 102. The video editor 300 has read and write access to the configuration storage data 403, but read only access to the video storage 402. The video storage 402 could be located in the same location as the configuration storage 403 and the video editor 300, or all three could be located in different locations connected by a network (such as the internet).

When using the video editor 300 to configure ads on a live stream video, the video storage 402 is a live source for video rather than a stored file. The ads 101 are stored in the configuration storage 403 and can be turned on or off dynamically by the editor as the live stream video proceeds. In some embodiments, the live stream creator toggles a Show/Hide button on his screen to active or hide the ads 101. In another embodiment, a remote operator Shows or Hides the specific ads 101.

The video reader 100 runs on a server. This could be the same server as the video editor 200 or it could have its own server. The video reader 100 could reside on the same server as the video storage 402 and/or the configuration storage 403. When not on the same device, the video reader 100 access the video storage 402 and the configuration storage 403 over a network such as the internet. Access is read only, as the reader 100 does not change either the configuration or the video.

In this embodiment, the viewer starts the viewer browser 404 on a personal computing device. The viewer browser 404 contacts the video reader 100 server to retrieve the web pages associated with the video reader. This page can be seen in FIGS. 1 and 2. Internet protocols such as HTTP, TCP/IP, UDP, RTP, and RTCP are used to move the web pages (and the video) from the video reader 100 and the viewer browser 404. Content is delivered using programming constructs such as HTML, XML, Java, Javascript, PHP, CSS, AJAX, or similar. The viewer browser 404 runs on a personal computing device such as a personal computer, a laptop, a mobile phone, a tablet, a smartphone, a smartwatch or similar device.

The video storage 402 device is a special purpose, high speed, large capacity storage device or a network of storage devices that distribute the videos to local locations, such as an Akamai network of storage devices. The configuration storage 403 is similarly a special purpose, high speed, large capacity storage device or a network of storage devices that distribute the configuration of the videos to local locations.

### Hardware Description

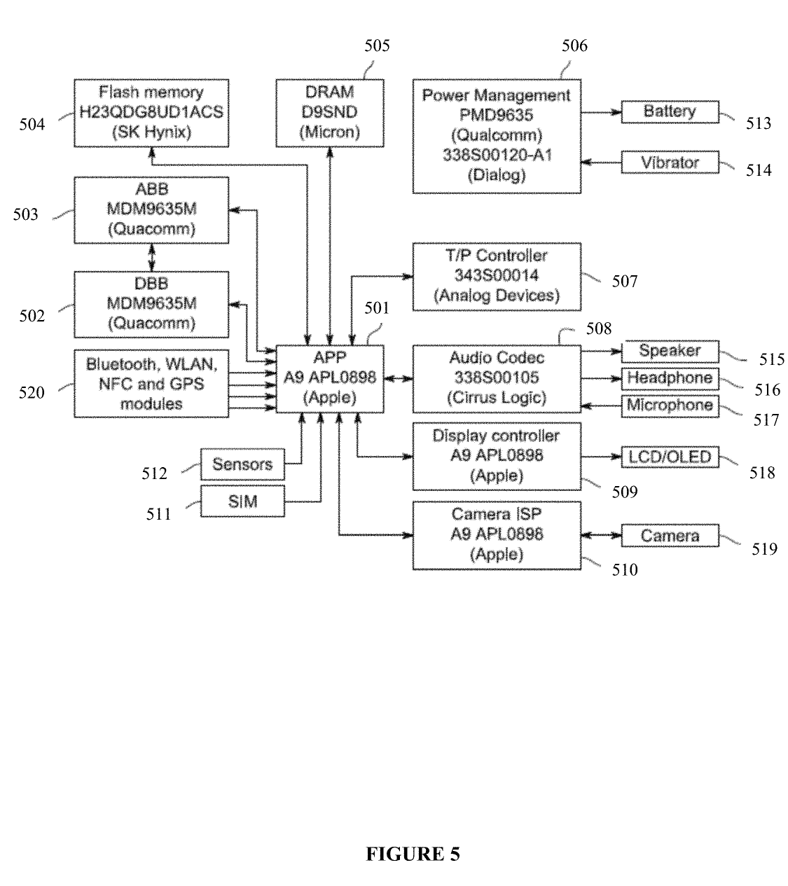

FIG. 5 shows the electrical functional diagram of an Apple smartphone, called the iPhone 6S, and show the data flow between the various functional blocks. The iPhone is one embodiment of a personal computing device. Other smartphones, personal computers, tablets, embedded computers, wearable devices, smart watches, laptops, smart televisions, and similar personal computing devices are used in other embodiments. The center of the functional diagram is the Apple A9 64-bit system on a chip 501. The A9 501 features a 64-bit 1.85 GHz ARMv8-A dual-core CPU. The A9 501 in the iPhone 6S has 2 GB of LPDDR4 RAM included in the package. The A9 501 has a per-core L1 cache of 64 KB for data and 64 KB for instructions, an L2 cache of 3 MB shared by both CPU cores, and a 4 MB L3 cache that services the entire System on a Chip and acts as a victim cache.

The A9 501 includes an image processor with temporal and spatial noise reduction as well as local tone mapping. The A9 501 directly integrates an embedded M9 motion coprocessor. In addition to servicing the accelerometer, gyroscope, compass, and barometer 512, the M9 coprocessor can recognize Siri voice commands. This M9 coprocessor can be used to authenticate users using voice recognition. The A9 501 is also connected to the SIM card 511 for retrieving subscriber identification information.

The A9 501 interfaces to a two-chip subsystem that handles the cellular communications 502, 503. These chips 502, 503 interface to LTE, WCDMA, and GSM chips that connect to the cellular antenna through power amps. These chips 502, 503 provide the iPhone with voice and data connectivity through a cellular network.

In addition to the on chip memory of the A9 501, the A9 501 connects to flash memory 504 and DRAM 505 for additional storage of data.

Electrically connected, through the power supply lines and grounds, to the A9 501 and the rest of the chips 502-519 is the power management module 506. This module 506 is also connected via a data channel to the A9 501. The power management module 506 is connected to the battery 513 and the vibrator 514.

The Touch Screen interface controller 507 is connected to the A9 501 CPU. The Touch Screen controller also interfaces to the touch screen of the iPhone. The Touch Screen can be used to authenticate the user either through fingerprint recognition, keystroke pattern recognition, or through passcode entry. The Touch Screen is also used to determine focus.

The Audio codec 508 in the iPhone is connected to the A9 501 and provides audio processing for the iPhone. The Audio codec 508 is also connected to the speaker 515, the headphone jack 516, and the microphone 517. The Audio codec 508 provides a high dynamic range, stereo DAC for audio playback and a mono high dynamic range ADC for audio capture. The Audio codec 508 may feature high performance up to 24-bit audio for ADC and DAC audio playback and capture functions and for the S/PDIF transmitter. The Audio codec 508 architecture may include bypassable SRCs and a bypassable, three-band, 32-bit parametric equalizer that allows processing of digital audio data. A digital mixer may be used to mix the ADC or serial ports to the DACs. There may be independent attenuation on each mixer input. The processing along the output paths from the ADC or serial port to the two stereo DACs may include volume adjustment and mute control. One embodiment of the Audio codec 508 features a mono equalizer, a sidetone mix, a MIPI SoundWire or I²S/TDM audio interface, audio sample rate converters, a S/PDIF transmitter, a fractional-N PLL, and integrated power management. In some audio codecs, digital signal processing and fast Fourier transformation functionality is available, either integrated into the sound processing or available to the CPU 501 for offloading processing from the CPU.

The A9 501 chip also interfaces to a Camera integrated signal processor 510 chip, the Camera chip 510 connected to the camera 519. The camera 519 can be used for authentication purposes, utilizing a facial recognition algorithm to authenticate the user. The camera 519 could also be used to recognize other images for authentication, for instance a passport or driver's license could be scanned for authentication.

There is also a Display Controller 509 that provides the interface between the A9 501 chip and the LCD (or OLED) screen 518 on the iPhone. The Display Controller 509 is a special purpose controller designed for high performance processing of video streams so that the video streams can be displayed without delay. The screen 518 could be used in to display the videos, the advertisements, and the display information.

The wireless subsystem 520 provides connectivity to Bluetooth, WLAN, NFC and GPS modules. This handles all of the non-cellular communications to the Internet and to specific devices. The Bluetooth devices could include a variety of microphones, headsets, and speakers. The wireless subsystem 520 interfaces with the A9 501 chip.

The foregoing devices and operations, including their implementation, will be familiar to, and understood by, those having ordinary skill in the art.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

1. A method of displaying advertisements on a video stream, the method comprising:
presenting the video stream on a screen of a personal computing device, the video stream displayed in browser using information from a video reader that incorporates information from a configuration storage;
sensing a location of focus on the personal computing device screen;
displaying, when the focus is on the video screen portion of the screen, an advertisement, where the advertisement is displayed according to the information from the configuration storage, said information determining when, relative to the start of the video stream, to start displaying the advertisement and when the stop displaying the advertisement.

2. The method of claim 1 further comprising redirecting the screen to a web page located at a hypertext link when the advertisement is clicked.

3. The method of claim 1 further comprising executing a code snippet when the advertisement is displayed, permitting access to a third party application.

4. The method of claim 1 wherein the video stream is a live stream video.

5. The method of claim 1 wherein the video stream is a previously recorded stored video.

6. The method of claim 1 wherein the focus is sensed according to a location of a cursor.

7. The method of claim 1 wherein the focus is sensed according to a tap on a touchscreen.

8. The method of claim 1 wherein the advertisement is opaque when displayed over the video.

9. The method of claim 1 wherein the personal computing device is a smartphone.

10. The method of claim 1 wherein the information specifies the location of the advertisement on the screen.

11. A personal computing device for displaying advertisements on a video stream, the device comprising:
a screen on the personal computing device, electrically connected to a special purpose processing unit;
a pointing mechanism for specifying focus on the screen, electrically connected to the special purpose processing unit;
a network interface electrically connected to the special purpose processing unit for connecting to a video reader, which accesses a video storage and a configuration storage;
a browser operating on the special purpose processing unit of the personal computing device, wherein the video stream is presented on the screen of a personal computing device by the browser, using information from the video reader that incorporates information from the configuration storage;
wherein an advertisement is displayed according to the information from the configuration storage, when the focus is on the video screen portion of the screen, said information determining when, relative to the start of the video stream, to start the display of the advertisement and when the stop the display of the advertisement.

12. The device of claim 11 wherein the browser is redirected to a web page located at a hypertext link when the advertisement is clicked.

13. The device of claim 11 wherein a code snippet is executed by the browser when the advertisement is displayed, permitting access to a third party application.

14. The device of claim 11 wherein the video stream is a live stream video.

15. The device of claim 11 wherein the video stream is a previously recorded stored video.

16. The device of claim 11 wherein the focus is sensed according to a location of a cursor.

17. The device of claim 11 wherein the focus is sensed according to a tap on a touchscreen, the touchscreen electrically connected to the special purpose processing unit.

18. The device of claim 11 wherein the advertisement is opaque when displayed over the video.

19. The device of claim 11 wherein the personal computing device is a smartphone.

20. The device of claim 11 wherein the information specifies the location of the advertisement on the screen.
